(19) United States
(12) Patent Application Publication
(10) Pub. No.: US 2006/0034500 A1
(43) Pub. Date: Feb. 16, 2006

(54) Method and device for image registration

(75) Inventors: Marcel Johannes Quist, Eindhoven (NL); Peter Roesch, Augsburg (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/534,828

(22) PCT Filed: Oct. 27, 2003
(86) PCT No.: PCT/IB03/04780

§ 371 Date: May 12, 2005

(30) Foreign Application Priority Data
Nov. 18, 2002 (EP) 02079775.9

(51) Int. Cl. G06K 9/00

(52) U.S. Cl. 382/130

(57) ABSTRACT

The present invention relates to a method of computing the transformation for transforming two images (10, 10′), in particular medial MR- or CT-images of a patient, one into the other. The motion pattern at tissue boundaries shows an abrupt change of local transformation parameters that can not be described by continuous transformation functions. To deal with this problem a clustering of corresponding control points (14) is proposed which all have similar or substantial by the same transformation parameters (t1-t4). Criteria for clustering are derived from the local transformation parameters. The transformation parameters for further control points (5, 6, 7), which belong to more than one cluster (C1, C2) are determined in two steps taking into account that the control point (5, 6, 7) could belong to only one of the clusters rather than by performing a conventional interpolation of the transformation parameters of neighbouring control points.

The present invention relates to a method of computing the transformation for transforming two images, in particular medical MR- or CT-images of a patient, one into the other. Moreover, the present invention relates to a corresponding device and to a computer program for implementing said method.

In numerous medical and non-medical applications of imaging methods a problem is encountered in that two images formed of the same object have to be analyzed as regards which elements in the images correspond to one another and how these elements have shifted and/or have become deformed from one image to the other. Such comparisons of two images are intended notably for the analysis of flexible objects and shapes. In the context of the automatic analysis of pairs of images, that mathematical transformation is computed which transforms the two images one into the other. Such a transformation may also be referred to as a motion and deformation field, since it indicates how every point of the first image has moved in the other image or how a surface element or volume element of the first image has become deformed in the second image. In the case of medical applications, the local distribution of the deformation or motion in an image can be directly visualized so as to support the diagnosis of, for example the growth of a tumor. Furthermore, the deformation can be used as the basis for cardiac applications, for a comparison of images formed before and after a treatment, and for the compensation of motions of a patient. From the deformation field, local elastic properties can be deduced. These elastic properties can reflect pathologies, for instance rigid tumors in soft environment.

Various methods have been proposed for the automatic computation of a motion and deformation field which transforms two different images of the same object one into the other. Many algorithms attempt to establish a correspondence between parting edges (J. Declerck, G. Subsol, J.-P. Thirion, N. Ayache, Automatic retrieval of anatomical structures in 3d medical images, Lecture Notes in Computer Science 950 (1995), p. 153) or boundaries (D. Davatzikos, J. L. Prince, R. N. Bryan, Image Registration Based on Boundary Mapping, IEEE Trans. Medical Imaging 15 (1996), p. 112) that have been extracted in both images. According to these methods, however, only a part of the information contained in the images is used. Therefore, the methods yield transformation parameters only for the lines of the selected characteristics and the transformation must subsequently be expanded to cover the entire volume.

An alternative approach consists in elastic registration that is based on gray values and utilizes the entire image contents. The calculation of a motion and deformation field means that a respective set of transformation parameters must be assigned to each sub-volume of the image (or even to each voxel). The calculation, therefore, is actually an optimization method for determining the field that produces maximum similarity between the images. A motion and deformation field thus represents a very large number of degrees of freedom. Overall optimization schemes for the elastic registration change the overall motion and deformation field in every step of the computation and hence also change a large number of parameters. A large number of local optima is to be expected during these methods and, therefore, in many cases the optimization method becomes stuck in one of the local optima instead of reaching the desired overall optimum.

In another method, that is, the so-called block matching, the image is subdivided into small sections which are separately assigned (P. J. Kostelec, J. B. Weaver, D. M. Healy, Jr., Multiresolution Elastic Image Registration, Med. Phys. 25 (1998), p. 1593). The method, illustrated on the basis of 2D images and proposed for 3D images, commences with a rigid registration of the overall image. Only a shift (translation and rotation of the image) takes place during a rigid transformation, but not a deformation, that is, a location-dependent expansion or compression of lengths. After the rigid registration, the image is successively subdivided into ever smaller sections that are then rigidly assigned again. Each section utilizes the registration parameters found in the “parent block” as initial estimated values for the own registration. Even though this method yields acceptable results for 2D images with comparatively small deformations, in 3D images not even an approximately rigid registration of image sections that are larger than approximately 1 cm is possible in the presence of large deformations. The quality of the initial estimated values, therefore, is very likely inadequate for successful registrations in the last steps of the algorithm where a given overlap is required between small corresponding blocks in the source image and in the target image.

Particularly in the case of global optimisation schemes, a large number of parameters, e.g. the positions of some 104 spline control points for typical 3D volumes, have to be varied. This results in a large number of local optima of the similarity measure and in a large number of function evaluations per optimisation step. In order to achieve tolerable computation times and to increase robustness, multi-resolution approaches are used. However, re-sampling the image at courser resolutions results in blurring of tissue boundaries and might result in unrealistic deformation fields.

In case of non-rigid registration algorithms an optimisation of the deformation field for each pixel or voxel of the reference image, e.g. about 134-106 voxels for a 5123 image, would take an unacceptable amount of time, so that the calculation of the deformation field is usually based on a set of sub-volumes, as proposed for block-matching, on control points of a continuous function, e.g. splines, or on the parameters of a global polynomial transformation. The continuity of these functions can successfully describe deformations where the spatial variation of local transformation parameters is smooth. Examples are deformations of the female breast. However, if anatomical entities move relative to each other, e.g. the liver moving relative to the ribs due to respiration, the real local transformation parameters are not continuous at the liver boundary. Current methods interpolate the dense deformation field at an image position from all control points close to this position even if the control points are located in different organs.

U.S. 2002/0054699 A1 discloses a method of computing the transformation which transforms two different images of an object one into the other while describing the motion or deformation of the object. In accordance with the method first the local transformation parameters are computed for sub-regions. By choosing the sub-regions so as to be sufficiently small, a rigid transformation can be used for this purpose. Starting from at least one first predetermined sub-region, the local transformation parameters of the neighboring sub-regions are successively computed, the starting values on which each computation is based being the already determined local transformation parameters of neighboring sub-regions. Using the local transformation parameters thus determined for sub-regions, the overall transformation can subsequently be computed. This template propagation procedure implicitly assumes a continuous variation of local transformation parameters, an assumption that is not justified in cases where anatomical entity is moved relative to each other so that discontinuities in the displacement field turn up.

Considering the foregoing it is an object of the present invention to provide a method of computing the transformation for transforming two images, in particular of the same object one into the other which avoids the above described problems, in particular avoids unwanted interpolation artifacts for points located close to tissue boundaries, increases computational efficiency and accuracy and reduces the required time for registration of the images.

This object is achieved according to the present invention by a method as claimed in claim 1 comprising the steps of:
a) initialising a set of control points in both images,
b) determining the transformation parameters for said control points,
c) performing a clustering of corresponding control points such that all control points of a cluster have substantially the same transformation parameters so as to obtain one or more clusters of control points,
d) determining the transformation parameters for further control points
d1) which do not belong to any cluster by an interpolation of the transformation parameters of neighbouring control points,
d2) which belong to one cluster by an interpolation of the transformation parameters of neighbouring control points of said one cluster, or
d3) which belong to more than one cluster by determining intermediate transformation parameters for each cluster based on an interpolation of the transformation parameters of neighbouring points of each of said clusters separately and by determining the transformation parameters from said intermediate transformation parameters.

A corresponding device according to the present invention is defined in claim 9. Furthermore, the present invention relates to a computer program for implementing the method as claimed in claim 10. Preferred embodiments of the invention are defined in the dependent claims.

The method according to the invention is intended to compute the mathematical transformation that transforms two different images one into the other. The images may notably be medical images which have been acquired, for example by means of an X-ray computed tomography (CT) apparatus or by means of a magnetic resonance (MR) tomography apparatus. In this context a transformation between two images is to be understood to mean a function which assigns the points of one image to the points of the other image while leaving the neighbor relations of the points unchanged. Thus, a transformation of this kind is a continuous function which is also referred to as a motion and deformation field, because it describes the motion of the points of the images from one image to the other in relation to the deformation of surface elements or volume elements. The function is preferably objective, so that it assigns each point of one image reversibly unambiguously to a point of the other image.

The present invention is based on the idea to add a new processing step in the context of non-rigid registration of a 2D or 3D target image to a reference image. This additional processing step shall be referred to as control point clustering and is performed as explained in the following.

Given a set of point pairs pᵢ,_{ref} and pᵢ,ₜᵣₐₙₛ (i=1, . . . , N) in the reference and target image respectively, for each of the points in the reference image, a set of transformation parameters tᵢ is first derived by global optimization steps or by a block matching method. Rather than treating each point on its own, neighboring points are grouped together in clusters Cⱼ (j=1, . . . , m) such that all points of a cluster have similar transformation parameters:
P_{i,ref}εCⱼ:N(tᵢ, Tⱼ)<s
where Tⱼ denotes the transformation parameters assigned to the cluster Cⱼ, the deviation is measured by a norm N and the maximum deviation from Cⱼ is given by threshold value s. For example, Tⱼ can be assigned to the average transformation parameters of all cluster points and N can be the length of the difference vector tᵢ-T_{J}.

Not all points p_{i,ref} need to belong to a cluster; one point can belong to more than one cluster. This is required to treat irregular motion patterns, e.g. in the lumen of MR cardiac images, and to avoid binary cluster borders which would be heavily affected by noise and inaccuracies in the values of transformation parameters.

In known interpolation methods the transformation parameters of a voxel at position r_{ref} is influenced by the properties of all control points p_{i,ref} in a certain area around r where the contribution of each control point depends only on the distance |r-pᵢ|. This often gives plausible values for positions at the centre of organs. However, the treatment of points closed to tissue boundaries is more problematic as the interpolation for these positions is based on control points belonging to different anatomical structures. This problem appears for the case of respiratory motion compensation where inaccuracies in the liver area turn up because control points positioned on the ribs are used to calculate the deformation field within the liver. This leads to inaccuracies because during inspiration the ribs follow the expansion of the chest while the motion of the liver is dominated by the movement of the diaphragm. The proposed method addresses this difficulty by imposing an additional cluster-based classification step during interpolation as defined in steps d1-d3:
If a control point does not belong to any cluster Cⱼ, the conventional interpolation process is applied (step d1).
If a control point belongs to exactly one cluster, the interpolation method preferably takes into account control points of the same cluster, preferably by suitable weighting factors (step d2).

For control points r belonging to more than one cluster, the transformation parameters are derived in two steps. First, for each cluster containing the control point, transformation parameters at the position r are deduced. This results in k sets of intermediate transformation parameters. In a second step, these intermediate transformation parameters are combined for determining the real transformation parameters (step d3).

Applying this method during global optimisation leads to a dynamically updated subdivision of the image into regions characterized by similar or substantially identical transformation properties. Applied after optimisation, the clustering step avoids unwanted interpolation artifacts for control points located close to tissue boundaries.

According to a preferred embodiment the transformation parameters in step d3 are determined by a combination and weighting of the intermediate transformation parameters. Further, in order to assign a control point to one or more clusters it can be checked, as proposed according to a further preferred embodiment, whether the control point lies within the convex hull of the cluster under consideration. Another possibility is to use the distance between the control point and the closest point of the cluster as a criterion.

According to another embodiment the transformation parameters are determined by a selection of one of the intermediate transformation parameters based on a similarity measure of the image information belonging to the control points under consideration. The similarity measure therein indicates, preferably based on image information, to which image object or to which cluster a particular control point should belong.

According to another aspect of the invention the clustering step is repeated for optimisation of the clusters in case a control point has been assigned to a particular cluster in previous step d. Thus, the clustering can be optimised.

The proposed clustering can be incorporated into a template propagation method as, for instance, described in P. Rösch, T. Netsch, M. Quist, G. P. Penney, D. L. G. Hill and J. Weese, “Robust 3D Deformation Field Estimation by Template Propagation”, vol. 1935, pages 521-530, MICCAI, Springer, 2000. In this case, clustering is performed dynamically during the propagation process. Rather than propagating starting estimates to neighbouring templates, the hypotheses that a set of templates forms a cluster is tested on the basis of local transformation parameters, and the clustering information is taken into account during propagation to avoid that starting values derived from templates belonging to one anatomical entity are used for another anatomical structure. An advantage of this method is that in addition to a set of correspondences a segmentation of the image in clusters is performed. This segmentation information can be refined afterwards.

According to another preferred embodiment control points can be interactively assigned to clusters by a user. Particularly in cases where the automatic clustering as inaccurate this will be advantageous and will improve accuracy of the method. In cases where it is not clear to which a control point belongs the method can be adapted to ask the user to make the decision or to ignore the particular control point.

From a conceptual point of view, the proposed invention and the advantages obtained by performing a clustering during non-rigid registration can be seen as an attempt to support image segmentation by the results of elastic registration.

The invention also relates to a computer program for computing the transformation that transforms two digitized images of an object, preferably two medical images acquired by means of computed tomography or magnetic resonance tomography, one into the other. The computer program is characterized in that it carries out a computation in conformity with one of the methods described above.

The invention also relates to a data carrier for a computer program on which a computer program of the kind set forth is stored. The data carrier may notably be a magnetic data carrier (disc, magnetic tape, hard disc), an optical data carrier (CD), a semiconductor memory (RAM, ROM . . . ) or the like. The data carrier may notably form part of a computer in which the computer program stored on the data carrier is executed.

Finally, the invention relates to a device for computing the transformation which transforms two digitized images of an object, preferably acquired by means of computed tomography or magnetic resonance tomography, one into the other. The device comprises a central processing unit and at least one memory unit with which the central processing unit is connected and to which it has access for reading and writing of data and commands. The memory unit may especially store the images to be transformed as well as a computer program to be executed by the central processing unit. The memory unit may notably be a magnetic data carrier (disc, magnetic tape, hard disc), an optical data carrier (CD), a semiconductor memory (RAM, ROM . . . ) or the like. The program that is stored in memory and that controls the central processing unit is adapted to calculate the transformation on the central processing unit by a method as it was explained above, i.e. the central processing unit executes the steps a) to d) as explained above. Moreover, the above-mentioned improvements of the method may be implemented in the computer program.

The invention will now be explained in more detail with reference to the drawings in which

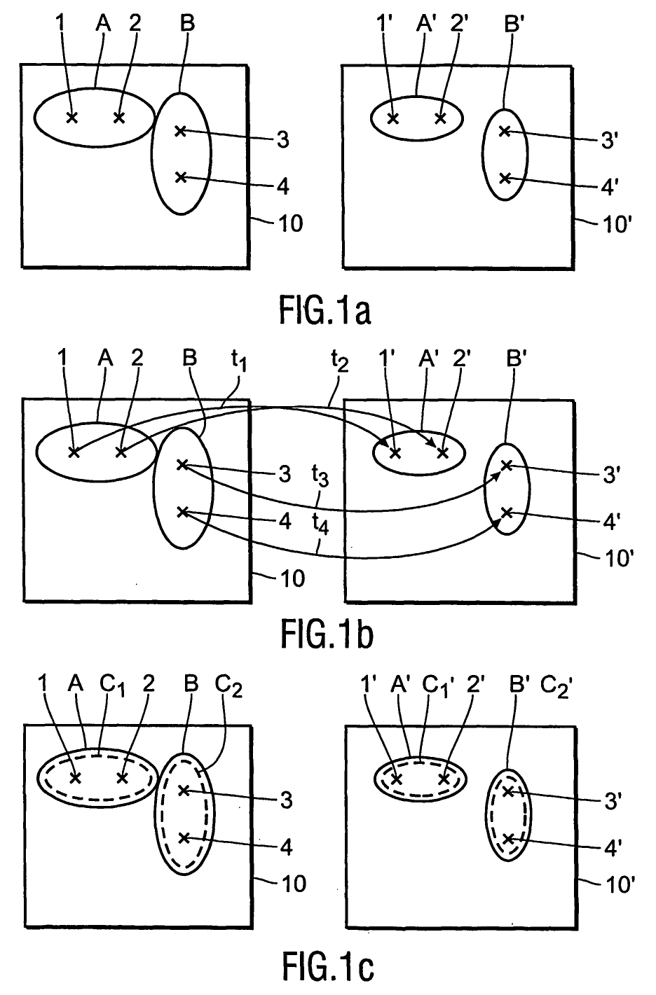

FIG. 1 illustrates the steps of the proposed method and

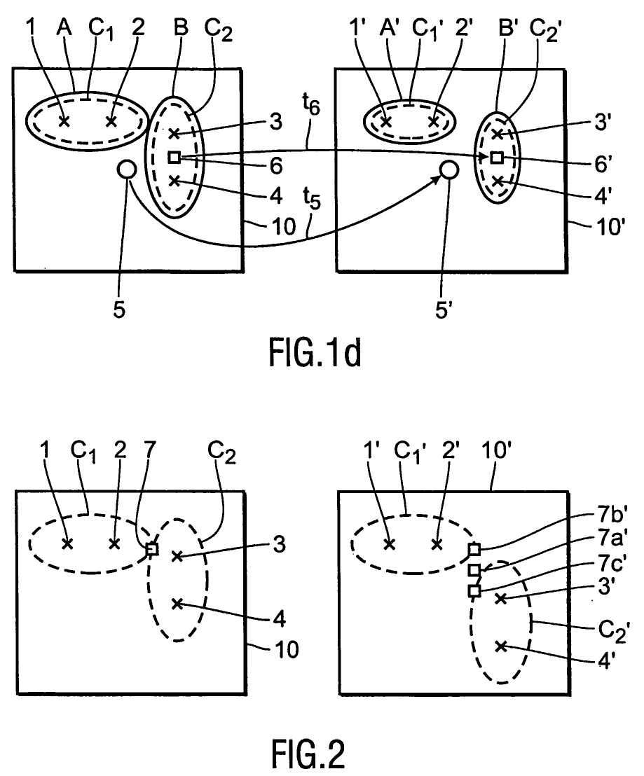

FIG. 2 illustrates the clustering step in case a control point belongs to more than one cluster.

FIG. 1 illustrates diagrammatically the steps of the method in accordance with the invention. The method concerns the computation of the transformation between two images 10, 10′ which assigns corresponding points of the images to one another. The images should have been acquired from the same object which, however, may have moved or become deformed between the acquisition of the two images, for instance due to respiration.

As shown in FIG. 1a in a first step a set of control points 1-4, 1′-4′ which are used as starting points, are initialized. Starting points 1, 2 are part of a first organ A while control points 3, 4 are part of a second organ B. Due to different deformations and/or movements the positions of the organs and the corresponding control points located therein are different in the target image 10′ compared to the reference image 10. As control points I-4 characteristic points such as dark or light spots, bifurcations or anomalies can be used which can be put on a regular grid (not shown).

In a subsequent step, which is illustrated in FIG. 1b, the transformation parameters t are determined for the control points 1-4, e.g. the transformation parameters t₁ for the transformation of control point 1 in the reference image 10 into its transformed position 1′ in the target image 10′. This is done for all control points 1-4 resulting in a set of transformation parameters t₁-t₄.

Thereafter a clustering is performed as shown in FIG. 1c. All control points that have similar or essentially identical transformation parameters t are therein combined as one cluster. In the present embodiment control points 1, 2 or 1′, 2′, respectively, are clustered in cluster C₁ or C₁′, respectively. Control points 3, 4 or 3′, 4′ are clustered into cluster C₂ or C₂′, respectively. Optionally, for each cluster average transformation parameters for all control points of the same cluster can be calculated and assigned to the individual control points of the cluster.

Subsequently, as illustrated in FIG. 1d, the transformation parameters for further control points 5 and 6 shall be determined. Considering control point 5 it can be seen that it does not belong to any of the existing clusters C₁, C₂. In this case the conventional known interpolation method is applied, i.e. the transformation parameters t₅ are determined based on an interpolation of transformation parameters of neighboring control points, i.e. for control point 5, for instance, by an interpolation of the transformation parameters t₁ and t₄ of control points 1 and 4.

In case of control point 6, which is part of cluster C₂, transformation parameters of neighboring control points which are part of the same cluster C₂ are used for interpolation, i.e. transformation parameters t₃ and t₄ of control points 3, 4 are used for interpolation of transformation parameters t₆ describing the motion of control point 6 in the reference image 10 into control point 6′ in the target image 10′.

For control points which belong to more than one cluster, additional criteria have to be considered. The situation is shown in FIG. 2 for control point 7 in case clusters C, and C₂ are located close to each other as shown in the reference image 10. As can be seen in the target image 10′ the clusters C₁, C₂ which could also be understood as the borderlines of different organs, move relative to each other resulting in the positions C₁, C₂ in the target image 10′. In case control point 7 is positioned at the point of contact of the clusters C₁, C₂ in the reference image 10 different transformation parameters t and thus different positions in the target image 10′ can be obtained depending on how the transformation parameters are calculated. Applying an interpolation using the neighboring control points 2 and 3 would result in position 7a′ while assuming that control point 7 either belongs only to cluster C₁ or cluster C₂, respectively, and thus only using control points 1, 2 or 3, 4, respectively, for the interpolation would lead to positions 7b′ or 7c′, respectively. Thus, according to the present invention in this situation intermediate transformation parameters t₇a, t₇b and t₇c are determined for each of said possible positions in a first step. Subsequently, it is determined which of these intermediate transformation parameters leads to the correct position of control point 7 in the target image 10′ by use of additional information such as, for instance, a similarity measure indicating to which of the image portions underlying the clusters C₁ and C₂ the control point 7 belongs or by using the distances between cluster point 7 and the enclosing area or perimeter, e.g. the convex hull, of the clusters C, and C₂ using as weighting factors for the determined intermediate transformation parameters t₇ₐ, t_{7b}, t_{7c}.

Under the assumption that control point 7 belongs to cluster C, the position 7b′ would thus be found, and the transformation parameters t_{7b} would be selected or determined as transformation parameters while a conventional interpolation method would result in position 7a′ and corresponding transformation parameters t₇ₐ. Thus, the above described problem at tissue boundaries can be solved.

A particular application of the proposed method is to support the optimization procedure for deformation field estimation if global optimization schemes are used. In that optimization procedure in a first step a set of control points as described above is initialized. Thereafter an optimization step is performed which leads to a modified control point distribution yielding a larger numerical value of the applied similarity measure, e.g. mutual information or local correlation. Thereafter a clustering of the corresponding points is performed. Therein, constraints based on “cluster membership” are imposed for the following optimization steps. For example, the parameter variation in the context of simple gradient optimization scheme can be synchronized with the cluster to speed up convergence and to improve the stability of the optimization. For Newton-like methods, common (or average) Hessian approximations for the cluster members can be calculated to improve the statistical significance of the Hessian particularly for noisy images.

By incorporating the derived constrains the next optimization step is performed, thus leading to an iteration. If the termination criterion, e.g. a predetermined value for the similarity measure, for the optimization is reached, the resulting parameters are stored, otherwise the optimization is continued.

The proposed method can also be used to implement an alternative to current multi-resolution approaches. Rather than reducing the image resolution or the spacing between control points from level to level, the method starts with the large threshold which results in large clusters. Then the threshold is successively set to smaller and smaller values thus implementing a coarse to fine procedure in parameter space rather than in the spatial domain.

For global elastic registration algorithms the proposed method leads to an improvement of the computational efficiency by reducing the dimensionality of search space. This is achieved by varying transformation parameters of clusters of control points rather than optimizing the parameters of each control point individually. Particular large, high resolution data sets resulting from recent developments in CT will benefit from this speed improvement. The robustness of the optimization process is improved as the influence of local deviations due to registration errors is reduced. In contrast to current biomechanical models, no time-consuming segmentation of the images is required. As further advantage more realistic deformation fields will be obtained minimizing the artifacts current schemes produce at tissue boundaries. Anomalies in the deformation pattern that indicate pathology can be detected, and the attention of the user can be directed to image areas where these deviations occur, e.g. by suitable color coding. During template propagation a dynamic clustering procedure will prevent starting estimates from one anatomical region to be propagated to other regions which show a different motion. This will increase the robustness of the method, e.g. at organ surfaces.

It should be noted that the images 10, 10′ may not only be images of the same object but can also be images of different objects, as for instance in the field of inter-patient registration. Further, one image can be an image of an object while the other image can be an image of a corresponding model of the object, as for instance in the field of model-template registration which is often used for the recognition of objects in an image.

While above registration of two images is illustrated, the invention is not limited to the registration of exactly two images. Nowadays there is an increasing tendency to acquire and analyse series of images to study motion patterns. The clustering is then not necessarily done on transformation parameters between two images, but may conceptually also be applied to transformation patterns over time, e.g. cardiac series for wall motion analysis where there is a repetitive motion pattern with the heart cycle (heart embedded in surrounding tissue with different motion characteristics) or lung series for respiration analysis/lung mechanics where there is a repetitive motion pattern with the breathing cycle.

Further, the invention is not limited to elastic registration by means of corresponding point-sets obtained by template registration and an interpolating scheme, which method is illustrated above referring to the figures. Other elastic registration schemes use e.g. a deformable grid rather than corresponding control points. These can also benefit from the present invention: Deformable grids should become more flexible in areas between clusters, otherwise the registration will not converge and finally result in unrealistic transformations. If the critical areas are known, which knowledge can be gained by the present invention, these grids can be made more flexible by either increasing the number of control points on the grid, only in critical areas rather than globally, or by allowing higher bending energies in those areas, i.e. by allowing more flexible deformations.

1. Method of computing the transformation for transforming two images, in particular medical MR- or CT-images of a patient, one into the other comprising the steps of:
a) initialising a set of control points in both images,
b) determining the transformation parameters for said control points,
c) performing a clustering of corresponding control points such that all control points of a cluster have substantially the same transformation parameters so as to obtain one or more clusters of control points,
d) determining the transformation parameters for further control points
d1) which do not belong to any cluster by an interpolation of the transformation parameters of neighbouring control points,
d2) which belong to one cluster by an interpolation of the transformation parameters of neighbouring control points of said one cluster, or
d3) which belong to more than one cluster by determining intermediate transformation parameters for each cluster based on an interpolation of the transformation parameters of neighbouring points of each of said clusters separately and by determining the transformation parameters from said intermediate transformation parameters.

2. Method as claimed in claim 1, wherein in step d3) the transformation parameters are determined by a combination and weighting of the intermediate transformation parameters.

3. Method as claimed in claim 2, wherein said weighting of the intermediate transformation parameters is based on weighting factors determined from the distances between the control point under consideration and the borderline of the cluster for which the intermediate transformation parameters have been determined.

4. Method as claimed in claim 1, wherein in step d3) the transformation parameters are determined by a selection of one of the intermediate transformation parameters based on a similarity measure of the image information belonging to the control points under consideration.

5. Method as claimed in claim 1, wherein after said steps d2) and d3) said clustering step c) is repeated for optimisation of the clusters.

6. Method as claimed in claim 1, wherein said method is used during template propagation.

7. Method as claimed in claim 1, wherein said method is used for increasing the flexibility of deformable grids having a number of control points used for elastic registration of images.

8. Method as claimed in claim 1, further comprising the step of interactively assigning control points to clusters by a user.

9. Device for computing the transformation for transforming two images, in particular medical MR- or CT-images of a patient, one into the other comprising:
a) means for initialising a set of control points in both images,
b) means for determining the transformation parameters for said control points,
c) means for performing a clustering of corresponding control points such that all control points of a cluster have substantially the same transformation parameters so as to obtain one or more clusters of control points,
d) means for determining the transformation parameters for further control points
d1) which do not belong to any cluster by an interpolation of the transformation parameters of neighbouring control points,
d2) which belong to one cluster by an interpolation of the transformation parameters of neighbouring control points of said one cluster, or
d3) which belong to more than one cluster by determining intermediate transformation parameters for each cluster based on an interpolation of the transformation parameters of neighbouring points of each of said clusters separately and by determining the transformation parameters from said intermediate transformation parameters.

10. Computer program comprising computer program means for causing a computer to perform the steps of the method as claimed in claim 1 when said computer program is executed on a computer.

11. Data carrier for a computer program on which the computer program as claimed in claim 10 is stored.
